(19) United States
(12) Patent Application Publication
(10) Pub. No.: US 2012/0047014 A1
(43) Pub. Date: Feb. 23, 2012

(54) METHOD AND SYSTEM FOR USING EMAIL RECEIPTS FOR TARGETED ADVERTISING

(75) Inventors: Yoelle Maarek Smadja, Haifa (IL); Andrei Broder, Menlo Park, CA (US); Vanja Josifovski, Los Gatos, CA (US); Melissa B. Stein, Sherman Oaks, CA (US)

(73) Assignee: Yahoo! Inc., Sunnyvale, CA (US)

(21) Appl. No.: 12/861,241

(22) Filed: Aug. 23, 2010

(51) Int. Cl. G06Q 30/00; G06F 17/30

(52) U.S. Cl. 705/14.53; 707/740; 707/E17.089

(57) ABSTRACT

Techniques for performing user classification based on email are provided. Emails stored in an email store may be analyzed to classify users. Information included in the stored emails may be extracted, and users may be classified into categories according to the extracted information. The extracted information may be analyzed in a manner so as to protect the personal information of the users according to any applicable privacy standards. Any number of types of emails may be analyzed to classify users in any number of ways. For instance, a plurality of commercial emails stored in the email store may be determined The commercial emails may be counted as conversions for an advertising campaign. The commercial emails may be parsed to extract commercial information. The commercial information may be parsed to generate user classification data. The user classification data may be used in various ways, including for targeting users with advertisements.

### BACKGROUND OF THE INVENTION

1. Field of the Invention

The present invention relates to data mining and online advertising.

2. Background

Advertisers and other entities in the online world are interested in assessing what products and services consumers are purchasing. Various techniques are currently used to make such an assessment. For example, the web pages that are viewed by users or the search queries that are entered by users into search engines may be tracked and analyzed to infer the purchasing habits of the users. However, such an analysis is subject to interpretation because the actual purchases are not known. In another technique, “conversions” may be measured to make such an assessment. A conversion may occur when a user interacts with an online advertisement in a manner desired by the advertiser. For example, a conversion may occur when the user selects (e.g., clicks on) the advertisement to cause an action to occur, such as displaying further information about the advertised item and providing an interface that the user may use to purchase the item (e.g., by displaying the advertiser's website, etc.). In another example, a conversion may occur when the user actually purchases the advertised item. By tracking conversions, advertisers can better assess the effectiveness of their advertisements, and can better learn what products and services are being purchased by consumers.

Currently, to determine when such a conversion occurs, a pixel or beacon is present that is associated with an online advertisement. The pixel or beacon is activated when a user interacts with the advertisement in a predetermined manner to indicate that a conversion has occurred. However, this technique has disadvantages, including being labor-intensive, limiting the potential for granular targeting, and not operating at scale. As such, further techniques are desired for measuring conversions and/or for otherwise assessing what products and services that consumers are purchasing.

### BRIEF SUMMARY OF THE INVENTION

Various approaches are described herein for, among other things, classifying users based on email associated with the users. For instance, email that is stored in an email store (e.g., in email mailboxes of the users) may be analyzed to classify the users. Information included in the emails may be extracted, and the users may be classified into one or more user categories according to the extracted information. The user categories may be used in various ways, including being used to determine purchasing habits of the users, to provide conversion information, and/or may be used in further ways.

The extracted information may be analyzed in a manner so as to protect the personal information of the users according to any applicable privacy rules or regulations. For instance, anonymous email targeting may be implemented. In such an implementation, any user personal information contained in the email may be disassociated (e.g., deleted, not extracted from the email, maintained separately, etc.) from other information extracted from the email. In another implementation, personalized email targeting may be implemented. In such an implementation, a user may be enabled to opt-in or opt-out of having the user's personal information associated with the other information extracted from the emails. A default setting may be used to “disassociate-by-default” user personal information from the other information extracted from the emails.

Any number of types of emails may be analyzed to classify users in any number of ways. For instance, in one example method implementation, a plurality of emails may be stored in an email store. A plurality of commercial emails stored in the email store may be determined The commercial emails may be parsed to extract commercial information included in the commercial emails. The commercial information may be parsed to generate user classification data.

In example system implementation, a user classifier is provided. The user classifier includes a commercial email determiner, a commercial email parser, and a commercial information processor. The commercial email determiner is configured to determine a plurality of commercial emails in an email store. The commercial email parser is configured to parse the commercial emails to extract commercial information included in the commercial emails. The commercial information processor is configured to process the commercial information to generate user classification data.

Furthermore, the commercial information processor may include a commercial information analyzer and a user classification data generator. The commercial information analyzer is configured to analyze the commercial information to categorize one or more users in one or more categories. The user classification data generator is configured to generate user classification data that indicates the one or more users categorized in the one or more categories.

In one example aspect, the commercial information analyzer is configured to analyze the commercial information to categorize each of the users in one or more of a shopping category, a frequent shopper category, a spending level category, a time-based purchaser category, a purchase time category, a purchase frequency category, an average purchase amount category, a purchaser demographics category, a similar purchasing characteristics category, an exclusion category, and a correlated purchases category.

Generated user classification data may be used in various ways. For instance, in one implementation, user profiles may be generated based on the user classification data. In another implementation, online advertisements may be selected for display based on the generated user classification data.

Computer program products are also described herein that enable classification of users using information extracted from email, and that enable further embodiments as described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of a data communication system, according to an example embodiment.

FIG. 2 shows a block diagram of an email server, according to an example embodiment.

FIG. 3 shows a block diagram of an example of the data communication system of FIG. 1, according to an embodiment.

FIG. 4 shows a flowchart for classifying users, according to an example embodiment.

FIG. 5 shows a block diagram of a user classifier, according to an example embodiment.

FIG. 6 shows a block diagram of commercial email determiner, according to an example embodiment.

FIG. 7 shows a block diagram of commercial email parser, according to an example embodiment.

FIG. 8 shows a block diagram of a commercial information processor, according to an example embodiment.

FIG. 9 shows a flowchart for processing commercial information to classify users, according to an example embodiment.

FIG. 10 shows a block diagram of commercial information analyzer, according to an example embodiment.

FIG. 11 shows a block diagram of a user profile generator, according to an example embodiment.

FIG. 12 shows a process for selecting online advertisements, according to an example embodiment.

FIG. 13 shows a block diagram of an example advertisement network, according to an embodiment.

FIG. 14 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Techniques for using emails to determine conversions and to classify users for various purposes are described herein. Email that is stored in an email store may be analyzed to classify the users. Information included in the emails may be extracted, to provide conversion information, and to enable the users to be classified into one or more user categories according to the extracted information.

For instance, in one embodiment, commercial email receipts are used as conversions for personal and/or anonymous targeting for online advertising. Machine reading of email header and/or email body content may be performed to determine what users are purchasing. The purchasing determination may be used as conversion-based data within online advertising targeting models according to anonymous targeting and/or personalized targeting techniques. Anonymous targeting may be performed to use one or more user's commercial email habits to reason about the habits of other users. In such case, there is no association of a user back to the original email recipient. According to personalized targeting, an association between users and their email receipts may be maintained.

Embodiments provide numerous advantages over conventional approaches. For example, embodiments provide a clean determinant of a user conversion as compared to search query or browsing behavior. An email receipt for a purchased item transmitted from a commercial entity to a user provides a clear indication that the user purchased the item, and thus provides a clear indication of a conversion. Embodiments simplify techniques for determining a conversion. For example, pixels or beacons do not need to be setup and/or managed, as in conventional techniques. Furthermore, embodiments enable additional data to be provided that is not typically available with pixel-based conversion. Examples of such data include a value of a conversion, an identification of a product within the conversion, a time left on a contract if a subscription-based conversion has occurred, and further data.

Example embodiments are described in further detail in the following subsections.

### II. Example Systems and Methods for Classifying Users Based on Emails

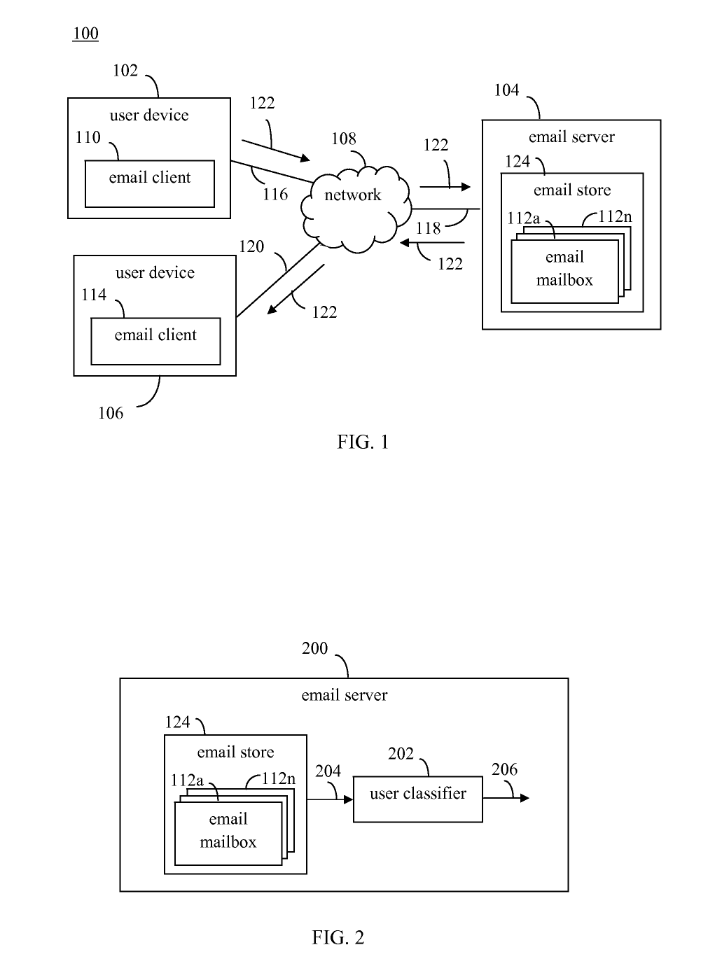

In embodiments, emails delivered between entities may be analyzed to determine conversions and to classify one or both of the entities. Such embodiments may be implemented in various environments. For example, FIG. 1 shows a block diagram of a data communication system 100, according to an example embodiment. As shown in FIG. 1, system 100 includes a first user device 102, an email server 104, a second user device 106, and a network 108. System 100 is described as follows to illustrate email delivery between entities.

First and second user devices 102 and 106 may each be any type of device that enables a user to send and receive email, including a desktop computer (e.g., a personal computer), a mobile computer or computing device (e.g., a Palm® device, a RIM Blackberry® device, a personal digital assistant (PDA), a laptop computer, a notebook computer, etc.), a smart phone, or other type of computing device. Email server 104 may include one or more servers, which may be any type of computing device described herein or otherwise known that facilities delivery of emails. User device 102, user device 106, and email server 104 are communicatively coupled by network 108. Network 108 may include one or more communication links, communication networks, and/or communication devices (e.g., routers, switches, hubs, etc.). For instance, network 108 may be a PAN (personal area network), a LAN (local area network), a WAN (wide area network), or a combination of networks, such as the Internet. First, second, and third communication links 116, 118, and 120, which respectively couple user device 102, email server 104, and user device 106 to network 108, may include any number of communication links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

System 100 is configured to enable devices such as user devices 102 and 106 to communicate with each other via email. For example, as shown in FIG. 1, user device 102 includes an email client 110, and user device 106 includes an email client 114. Email clients 110 and 114 operate to manage user email at user devices 102 and 106, respectively. For instance, email clients 110 and 114 may be mail user agents (MUAs) or other types of email clients. A first user at user device 102 may interact with an email user interface of email client 110 to generate an email addressed to a second user, or the email may be generated automatically at user device 102. The generated email is transmitted from user device 102 as email 122 in a first communication signal according to any suitable protocol (e.g., using the Simple Mail Transfer Protocol (SMTP) or other communication protocol). Network 108 is configured to deliver email 122 to an email mailbox of the second user. As shown in FIG. 1, email 122 may be transmitted through first communication link 116, network 108, and second communication link 118 to email server 104.

Email server 104 receives email 122 in the transmitted first communication signal. Email server 104 may be a mail transfer agent (MTA) or other type of email server configured to transfer email between user devices. As shown in FIG. 1, email server 104 includes an email store 124. Email store 124 stores email for a plurality of users. For example, as shown in FIG. 1, email store 124 may store user emails in email mailboxes 112, such as email mailboxes 112a-112n, with each email mailbox 112 being associated with a particular user. Thus, email 122 may be stored in email store 124 in an email mailbox 112 associated with the second user, such as email mailbox 112a.

The second user may desire to check email mailbox 112a for any received emails. For instance, at second user device 106, the second user may interact with a user interface of email client 114 to initiate a download of email from email mailbox 112a, or email client 114 may initiate the email download automatically (e.g., using a Post Office Protocol (POP) or other communication protocol). As shown in FIG. 1, any emails stored in email mailbox 112a, including email 122, may be transmitted to user device 106. Email 122 is transmitted in a second communication signal from email server 104. The second communication signal is transmitted through second communication link 118, network 108, and third communication link 120, and is received by user device 106. The second user may subsequently read email 122 at user device 106.

FIG. 1 is provided for illustrative purposes, and is not intended to be limiting. In embodiments, emails may be transmitted between user devices in alternative ways. For instance, in another embodiment, the first user may log into email server 104 to generate email 122 at email server 104. Additionally or alternatively, the second user may log into email server 104 to access and read email 122 in email mailbox 112a.

In an embodiment, email stored in email store 124 may be read and analyzed to extract information that may be used to determine conversions and to classify users. For instance, FIG. 2 shows a block diagram of an email server 200, according to an example embodiment. As shown in FIG. 2, email server 200 includes email store 124, which includes email mailboxes 112a-112n. Furthermore, as shown in FIG. 2, email server 200 includes a user classifier 202. As shown in FIG. 2, user classifier 202 receives emails 204 from email mailboxes 112a-112n in email store 124. Emails 204 may include emails from all of email mailboxes 112a-112n, or may include emails from selected email mailboxes 112a-112n (e.g., according to user opt-in/opt-out selections, etc.). User classifier 202 is configured to extract information from emails 204, and to classify the users associated with emails 204 (e.g., the targeted email recipients) according to the extracted information. As shown in FIG. 202, user classifier 202 generates user classification data 206. User classification data 206 may include one or more categories of users. User classification data 206 may be used in various ways. For example, in an embodiment, user classification data 206 may be used to select advertisements to be displayed to users.

Note in an embodiment, as shown in FIG. 2, user classifier 202 may be included in an email server, such as email server 200. In another embodiment, user classifier 202 may be located in a computer system that is separate from an email server. In embodiments, email store 124 may store email for any number of users, including thousands or millions of users, and may include any number of email mailboxes 112. By having access to large numbers of emails associated with a large number of users, user classifier 202 is enabled to generate user classification data 206 that leverages a large amount of knowledge extracted from the emails. By utilizing a large amount of knowledge, an amount of “noise” can be reduced when inferring information for a single user or for a single type of commercial mail message in a “wisdom of the crowds” type of approach.

In embodiments, user classifier 202 may be configured to classify the users in a personalized manner or in an anonymous manner. For instance, in an example of personalized user classification, users may be enabled to opt-in to a user classification system to allow their personal information to be associated with one or more generated user categories. Alternatively, users may be enabled to opt-out of having their personal information associated with the one or more of the generated user categories, and/or their personal information may not be associated with the one or more generated user categories by default. User classifier 202 may be configured to protect personal information of users according to any applicable privacy rules or regulations.

User classifier 202 may be configured to classify users according to any type of information obtainable from emails 204. Examples of such information include commercial information, social information, hobby-related information, etc. Example embodiments for classifying users according to commercial information are described in the following subsections. Such embodiments are not intended to be limiting, and in further embodiments, users may be classified according to other types of information extracted from email.

### A. Example Systems and Methods for Classifying Users According to Commercial Emails

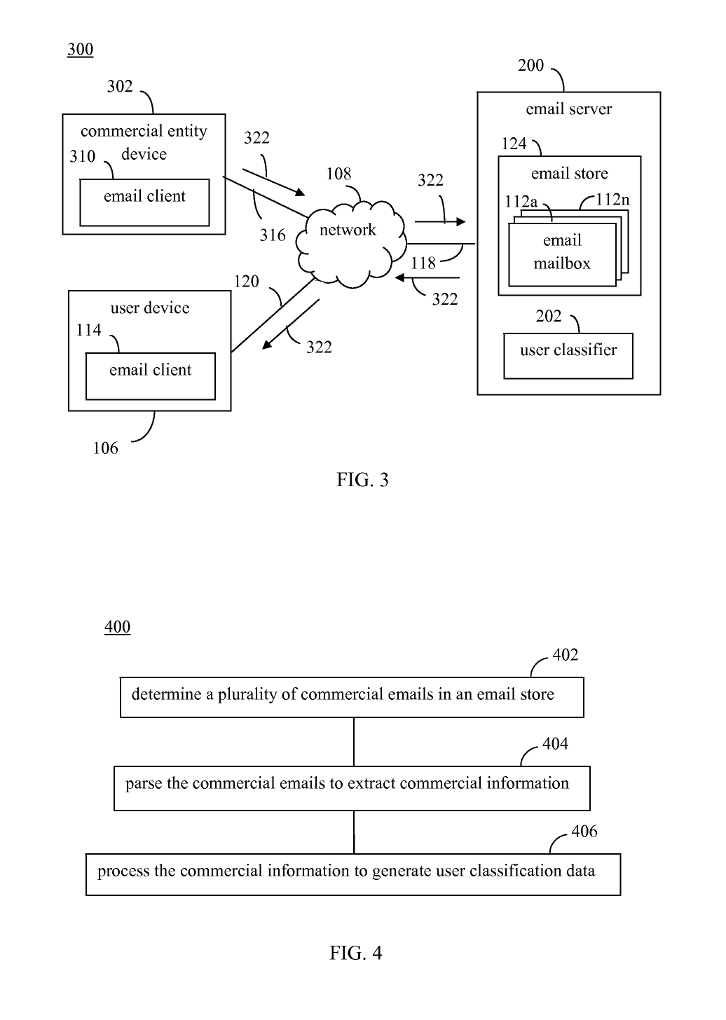

In embodiments, emails delivered between entities may be analyzed to determine characteristics of the entities that may be used to classify one or both of the entities. Such embodiments may be implemented in various environments. For example, system 100 of FIG. 1 may be configured in various ways to enable classification of users. For instance, FIG. 3 shows a block diagram of a data communication system 300, according to an example embodiment. Data communication system 300 is configured to classify users according to commercial information. In the example of system 300 in FIG. 3, commercial emails, such as email purchase receipts/confirmations and/or other emails from vendors, that are addressed to users are processed by user classifier 202 to classify the users. System 300 is described for purposes of illustration, and in further embodiments, users may be classified in other ways, according to other types of emails, as would be apparent to persons skilled in the relevant art(s) from the teachings herein. Such additional user classification embodiments are within the scope and spirit of the present invention.

Data communication system 300 of FIG. 3 is similar to system 100 of FIG. 1, with email server 200 of FIG. 2 being included in system 300 (in place of email sever 104 of FIG. 1). As shown in FIG. 3, email server 200 includes email store 124 (which includes email mailboxes 112a-112n) and user classifier 202. Furthermore, system 300 includes a commercial entity device 302 as an example of user device 102 of FIG. 1. Commercial entity device 302 includes an email client 310 configured to manage email. A user of user device 106 may purchase an item (e.g., a product or service) from a vendor associated with commercial entity device 302. For example, the user of user device 106 may interact with a website (e.g., a web service) of commercial entity device 302 to purchase the item from the vendor, may communicate with the vendor by phone to purchase the item, or may purchase the item in any other manner. As a result of the purchase transaction, commercial entity device 302 transmits a receipt email 322, which is an email that confirms the purchase transaction, and may indicate attributes of the transaction, such as the item purchased, a purchase price, the date of purchase, an estimated delivery date (if applicable), etc.

Email 322 is transmitted from commercial entity device 302 in a first communication signal according to any suitable protocol. Network 108 delivers email 322 to an email mailbox of the second user. As shown in FIG. 1, email 322 may be transmitted through first communication link 116, network 108, and second communication link 118 to email server 200. Email server 200 receives email 322, and email store 124 may store email 322 in email mailbox 112a associated with the user of user device 106.

The user of user device 106 may check email mailbox 112a (e.g., by interacting with a user interface of email client 114). Email 322 may be read by the user by logging into email server 200, or email 322 may transmitted in a second communication signal from email server 200 to user device 106 to be read by the user. The second communication signal is transmitted through second communication link 118, network 108, and third communication link 120, and is received by user device 106. The user of user device 106 is thereby enabled to view receipt email 322.

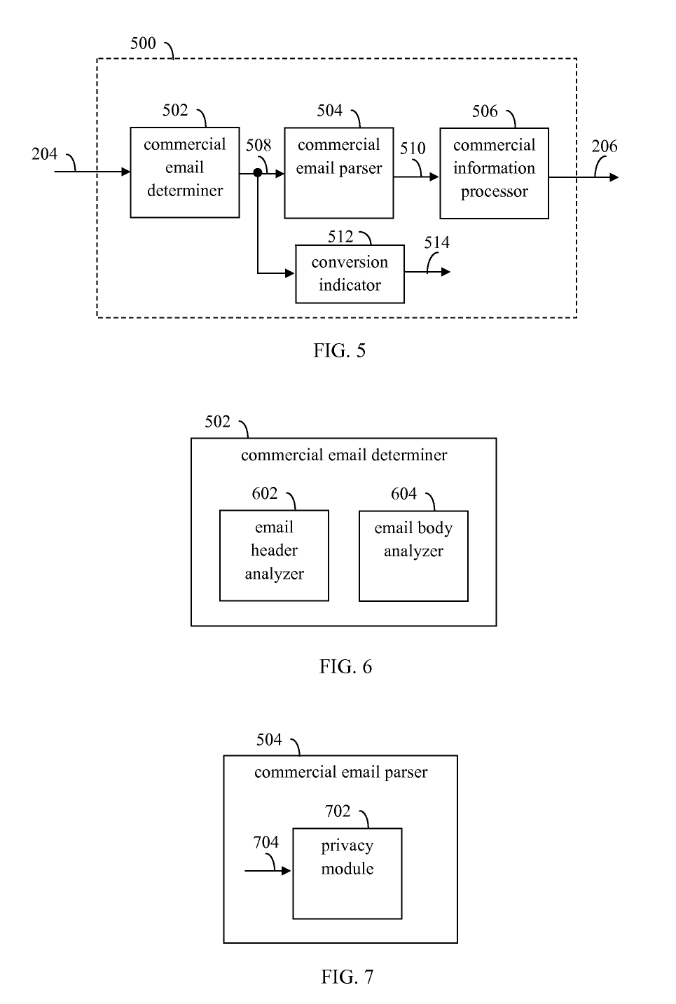

In this manner, commercial emails, such as receipt email 322 may be collected in email mailboxes 112 in email store 124. Commercial emails indicate that an item purchase transaction has occurred, and may be an email receipt/confirmation of the transaction, for example. User classifier 202 may be configured to analyze the commercial emails of email store 124 to classify users to generate user classification data 206 (FIG. 2). In embodiments, user classifier 202 performs user classification based on commercial emails in various ways. For instance, FIG. 4 shows a flowchart 400 for classifying users, according to an example embodiment. In an embodiment, user classifier 202 may operate according to flowchart 400. Furthermore, FIG. 5 shows a block diagram of a user classifier 500, according to an example embodiment. User classifier 500 is an example of user classifier 202 that is configured to classify users according to commercial information extracted from email. As shown in FIG. 5, user classifier 500 includes a commercial email determiner 502, a commercial email parser 504, a commercial information processor 506, and a conversion indicator 512. Flowchart 400 is described with respect to user classifier 500 for illustrative purposes. Further structural and operational embodiments will be apparent to persons skilled in the relevant art(s) based on the following description of flowchart 400 and user classifier 500.

Flowchart 400 begins with step 402. In step 402, a plurality of commercial emails in an email store is determined For example, as shown in FIG. 5, commercial email determiner 502 receives emails 204. Commercial email determiner 502 is configured to analyze emails 204 to determine any commercial emails included therein, which are output by commercial email determiner 502 as commercial emails 508.

Commercial emails are emails that provide an indication of commercial interest. For example, in one embodiment, commercial emails include email receipts to persons that indicate that an item purchase transaction has occurred, and that may be an email receipt/confirmation of the transaction. In another embodiment, commercial emails may further include emails to persons from commercial entities, whether or not the emails specifically indicate that an item purchase transaction has occurred. For example, if a person is on an email list of a car dealership, the person may likely have an interest in purchasing a car, or may have purchased a car recently. As such, an email to the person from the car dealership provides an indication of a commercial interest (i.e., the person's likely interest in cars). In another example, a person who receives email from a store probably shops at the store, and as such, the email from the store is an indication of a commercial interest. In still another example, a person who receives an email from a financial services company probably has an account at the financial services company, and as such, the email from the financial services company is an indication of a commercial interest.

Commercial email determiner 502 may be configured to determine commercial emails in emails 204 in any manner, including by analyzing the contents of each email of emails 204. For instance, commercial email determiner 502 may be trained on a set of commercial email receipts to determine aspects of commercial emails to search for when analyzing emails. In another example, commercial email determiner 502 may classify particular websites/domains as commercial or non-commercial, and may determine whether an email is commercial or non-commercial depending on the source website/domain. Commercial email determiner 502 may additionally and/or alternatively use further techniques to determine commercial emails, in embodiments.

For instance, FIG. 6 shows a block diagram of commercial email determiner 502, according to an example embodiment. As shown in FIG. 6, commercial email determiner 502 includes an email header analyzer 602 and an email body analyzer 604. Email header analyzer 602 is configured to analyze the header portions of each email included in emails 204 for commercial email indications to determine commercial emails. Email body analyzer 604 is configured to analyze the body portions of each email included in emails 204 for commercial email indications to determine commercial emails. In embodiments, either one or both of email header analyzer 602 and email body analyzer 604 may be present in commercial email determiner 502.

For example, email header analyzer 602 may analyze one or more fields of an email header, including one or more of the “From:” field, the “To:” field, the “Subject:” field, the “Date:” field, and/or any other email header field. For instance, the “From:” field may include an email address of the email sender (e.g., an email address associated with commercial entity device 302 of FIG. 3). Email header analyzer 602 may be configured to determine the sending domain name of the email address in the “From:” field, and to compare the determined sending domain name with a predetermined list of domain names previously determined to be associated with commercial entities/vendors. For example, an email address indicated in the “From:” field of an email may be auto-confirm@amazon.com, which has the domain name of “amazon.com.” The predetermined list of domain names maintained by email header analyzer 602 may include the domain name “amazon.com,” indicating that emails received from amazon.com are commercial emails. As such, email header analyzer 602 may compare the received domain name of amazon.com to the predetermined list of domain names to find a match, and thereby indicate the email as a commercial email received from a commercial entity. In such case, the email may be included in commercial emails 508 by email header analyzer 602.

In another example, an email address indicated in the “From:” field of an email may be josephsmith@hotmail.com, which has the domain name of “hotmail.com.” The predetermined list of domain names maintained by email header analyzer 602 may not include the domain name “hotmail.com,” indicating that emails received from hotmail.com are not commercial emails. As such, email header analyzer 602 may not find a match for hotmail.com in the predetermined list, and may thereby indicate the email as not being a commercial email, received from a non-commercial entity. In such case, the email may not be included in commercial emails 508 by email header analyzer 602.

In another example, email body analyzer 604 may analyze the contents of the body of an email to find email body attributes that may indicate the email as being transmitted from a commercial entity. For instance, email body analyzer 604 may search the contents of the body of the email for one or more words such as “order,” “grand total,” shipping,” “billing,” and/or “purchase” that indicate a commercial transaction has taken place, for a commercial entity/vendor name in a predetermined list of commercial entity/vendor names, for monetary amounts (e.g., indicated by a dollar sign or other monetary denomination), a predetermined signature block for a commercial entity/vendor, and/or other indication that the email is a commercial email.

For example, an email may include the following information in the email body:

***********************************************************
BILLING AND SHIPPING INFORMATION
***********************************************************
E-mail Address: joesmith@yahoo.com
Billing and Shipping Address:
Joseph Smith
5100 Main St.
Toledo, OH 43601
United States
***********************************************************
ORDER DETAILS
***********************************************************
Shipping estimate for these items: November 17, 2009
1 “Call of Duty: Modern Warfare 2”
Video Game; $59.99
Sold by: Amazon.com, LLC

Email body analyzer 604 may detect one or more of the words “billing,” “order,” “shipping,” or “sold,” may detect the vendor name “Amazon.com,” and/or may detect the monetary amount of “$59.99” to determine that the example email is a commercial email. Email body analyzer 604 may be configured to indicate the email as a commercial email by detecting a predetermined number and/or combination of such email body attributes.

The embodiment of commercial email determiner 502 shown in FIG. 6 is provided for purposes of illustration, and in other embodiments, commercial email determiner 502 may be configured in alternative ways to determine commercial emails.

As shown in FIG. 5, conversion indicator 512 receives commercial emails 508. When present, conversion indicator 512 is configured to generate conversions 514 to indicate conversions that have occurred based on commercial emails 508. For example, conversion indicator 512 may indicate a total number of conversions in conversions 514 based on the total number of commercial emails in commercial emails 508. In another embodiment, conversion indicator 512 may analyze each commercial email in commercial emails 508 to categorize each commercial email as a particular type of conversion, including categorizing conversions by vendor, by product type, etc. Conversion indicator 512 may be configured to count commercial emails as conversions for particular advertising campaigns. For instance, in an embodiment, conversion indicator 512 may be configured to count commercial emails associated with a particular vendor that are received after initiation of a related advertising campaign as conversions for that advertising campaign.

Referring back to FIG. 4, in step 404, the commercial emails are parsed to extract commercial information. For example, as shown in FIG. 5, commercial email parser 504 receives commercial emails 508. Commercial email parser 504 is configured to parse the emails included in commercial emails 508 for commercial information that may be used to classify users. As shown in FIG. 5, commercial email parser 504 outputs commercial information 510.

Commercial email parser 504 may be configured to parse commercial emails 508 in any manner to extract any type and amount of commercial information contained therein, as desired for the particular application. For instance, in embodiments, commercial email parser 504 may be manually configured and/or may be trained on example emails to extract purchased product information and/or any other commercially relevant information.

For example, commercial email parser 504 may contain a header parser configured to extract one or more fields of each email header, including one or more of the “From:” field, the “To:” field, the “Subject:” field, the “Date:” field, and/or any other email header field, and/or may include a body parser configured to extract information from the email body, such as one or more of a billing address, a shipping address, one or more item names, one or more item types, a purchase price for each item and a grand total (if more than one item is purchased), a commercial entity/vendor name, a shipping date, a lease expiration date, and/or any other information from the email body.

For instance, in one example commercial email, commercial email parser 504 may extract from the email header auto-confirm@amazon.com as the vendor email address from the “From:” header field, “Joseph Smith” as the user name from the “To:” header field, “Dec. 11, 2009” as the purchase date from the “Date:” header field. In this example, from the email body, commercial email parser 504 may extract “Call of Duty: Modern Warfare 2” as the item name, “video game” as the item type, “$59.99” as the item purchase price, “Toledo, Ohio 43601” as the shipping and billing city/state/zip code, and “Amazon.com” as the vendor name.

Commercial information 510 may include commercial information in any format. For example, commercial information 510 may be formed as a table, an array, a spreadsheet, or any other data structure. Commercial information 510 may include the extracted commercial information for each email organized together, may include the commercial information extracted for each user organized together (e.g., extracted commercial information for one or more emails addressed to the user being organized together), or may include extracted commercial information organized in any other manner.

Furthermore, in an embodiment, commercial email parser 504 may receive additional commercially-relevant information to include in commercial information 510 that may subsequently be used to classify users. For example, in an embodiment, commercial email parser 504 may receive one or more of browsing history data associated with users, searching data (e.g., queries entered into a search engine) associated with users, purchase records received by users from offline retailers, and/or further information. Such information may be received from any associated sources, including user accounts, a search engine, and/or other sources, and may be filtered according to any applicable privacy settings.

As described above, in embodiments, user classifier 202 may be configured to classify users in a personalized manner or in an anonymous manner. For instance, in an embodiment, email server 200 or other computing device may provide a user interface for users to configure privacy settings for accessing emails in their email mailboxes. For instance, a user may be enabled to interact with the user interface to opt-out of user classification, such that emails in their email mailbox are not analyzed by commercial email determiner 502, and thus are not included in commercial emails 508. The user may be enabled to opt-in to user classification such that emails in their email mailbox are analyzed by commercial email determiner 502, and thus may be included in commercial emails 508. In such case, the user may be enabled to select personalized targeting or anonymous targeting by further interacting with the user interface. According to personalized targeting, the user allows their personal information to be extracted by commercial email parser 504. According to anonymous targeting, the user does not allow their personal information to be extracted by commercial email parser 504.

For instance, FIG. 7 shows a block diagram of commercial email parser 504, according to an example embodiment. As shown in FIG. 7, commercial email parser 504 includes a privacy module 702. Privacy module 702 may receive a targeting selection 704 for each user having emails stored in email store 124. Targeting selection 704 may be selected by the user, and indicates whether the user selects personalized targeting or anonymous targeting. If targeting selection 704 indicates that the user selected personalized targeting, privacy module 702 is configured to enable commercial email parser 504 to extract personal information from commercial emails of the user. If targeting selection 704 indicates that the user selected anonymous targeting, privacy module 702 is configured to disable commercial email parser 504 from extracting personal information from commercial emails of the user. In such case, an anonymous label (e.g., user 1, user 2, etc.) may be associated with the extracted commercial information rather than the user's name or other personal information.

Referring back to FIG. 4, in step 406, the commercial information is processed to generate user classification data. For example, as shown in FIG. 5, commercial information processor 506 receives commercial information 510. Commercial information processor 506 is configured to process the commercial information in commercial information 510 to generate user classification data that indicates user categories. As shown in FIG. 5, commercial information processor 506 outputs user classification data 206.

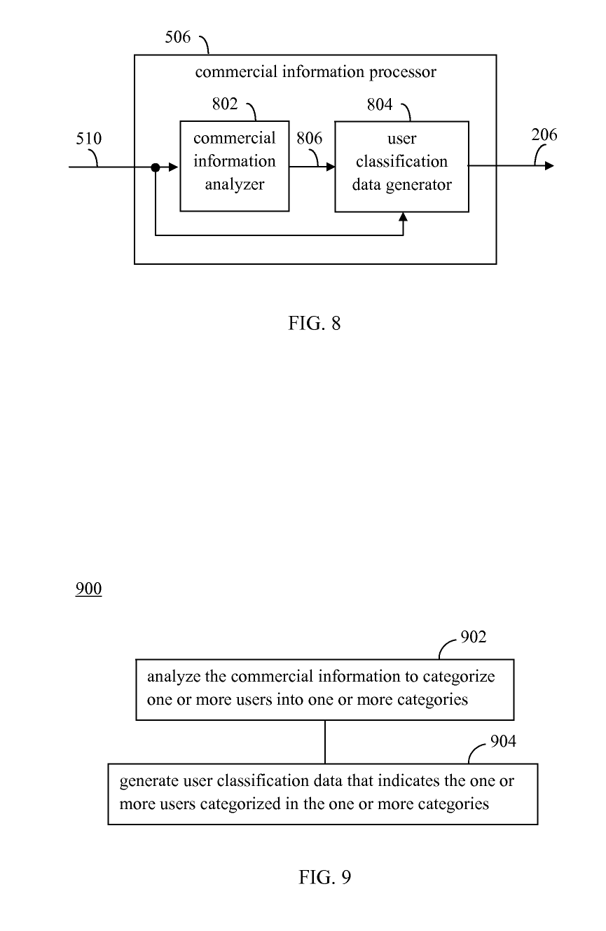

Commercial information processor 506 may be configured to process commercial information 510 in any manner, as desired for the particular application. For instance, FIG. 8 shows a block diagram of commercial information processor 506, according to an example embodiment. As shown in FIG. 8, commercial information processor 506 includes a commercial information analyzer 802 and a user classification data generator 804. Commercial information processor 506 of FIG. 8 is described with respect to FIG. 9. FIG. 9 shows a flowchart 900 for processing commercial information to classify users, according to an example embodiment. In an embodiment, commercial information processor 506 of FIG. 8 may operate according to flowchart 900. Further structural and operational embodiments will be apparent to persons skilled in the relevant art(s) based on the following description of flowchart 900 and commercial information processor 506 of FIG. 8.

Flowchart 900 begins with step 902. In step 902, the commercial information is analyzed to categorize one or more users into one or more categories. For example, as shown in FIG. 8, commercial information analyzer 802 receives commercial information 510. Commercial information analyzer 802 is configured to analyze commercial information 510 to categorize users into one or more categories. As shown in FIG. 8, commercial information analyzer 8802 generates category information 806, which indicates one or more categories and the one or more users categorized into each category.

For instance, with regard to personalized targeting, commercial information analyzer 802 may categorize each user identified in a “To:” field (the targeted email recipients) of a commercial email into one or more categories. In an anonymous targeting embodiment, commercial information 510 may include an anonymous user label (e.g., user 1, user 2, etc.) associated with the commercial information extracted by commercial email parser 504 for each user. Commercial information analyzer 802 may be configured to categorize the commercial information associated with each anonymous user label into one or more categories.

For example, with regard to personalized targeting, the user “Joseph Smith” may be categorized by commercial information analyzer 802 into a “video game user” category due to the above described example commercial email receipt for the purchase of the item “Call of Duty: Modern Warfare 2” of item type “video game.” If anonymous targeting is used (e.g., the user Joseph Smith elected anonymous targeting for his user profile and/or anonymous targeting is used by default), the anonymous user label “user 3587” (or other anonymous user label) for “Joseph Smith” may be categorized into the “video game user” category as described above. As a result, category information 806 may include an indication that Joseph Smith or “user 3587” is included in the “video game” category.

Any number and type of categories for users may be indicated in category information 806. Further examples of the categorization of users by commercial information analyzer 802 are described in the next section provided further below.

In step 904, user classification data is generated that indicates the one or more users categorized in the one or more categories. For instance, as shown in FIG. 8, user classification data generator 804 receives commercial information 806 and category information 806. Classification data generator 804 is configured to combine and/or organize commercial information 510 and category information 806 to generate user classification data 206. User classification data 206 includes commercial information 510 and indicates the one or more categories and the one or more users categorized into each category of category information 206. User classification data 206 may be formed as a table, an array, a spreadsheet, or any other data structure.

The embodiment of commercial email processor 506 shown in FIG. 8 is provided for purposes of illustration, and in other embodiments, commercial email processor 506 may be configured in alternative ways to analyze commercial information to generate user classification data.

The following subsection describes examples of categories for user classification.

### B. Examples Categories for User Classification

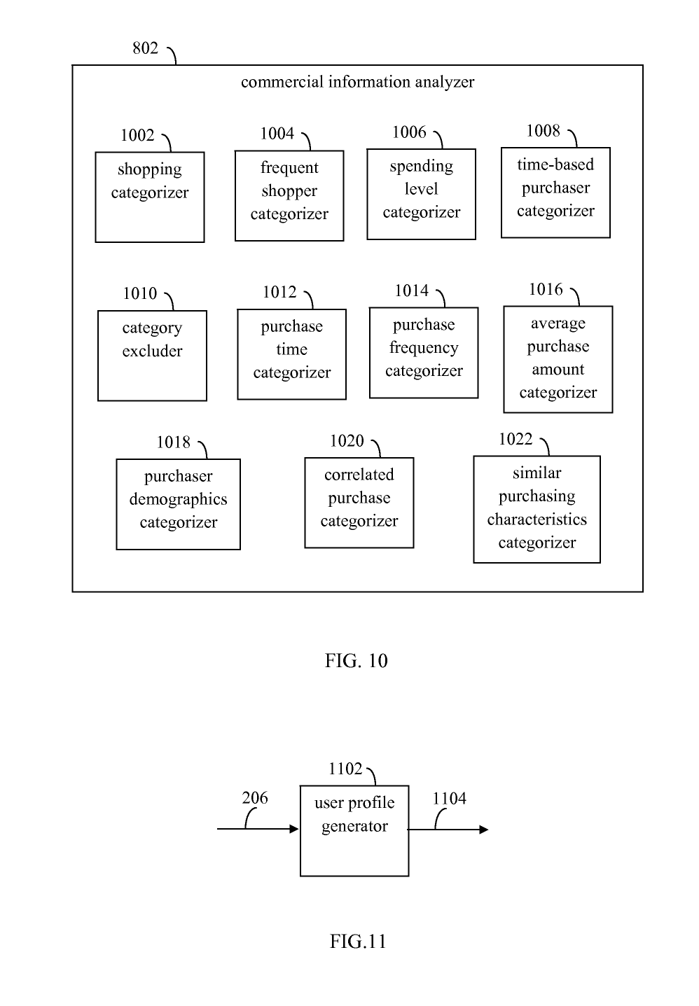

As described above, commercial information analyzer 802 is configured to analyze commercial information 510 to categorize users into one or more categories (e.g., according to step 902 in FIG. 9). As shown in FIG. 8, commercial information analyzer 802 generates category information 806, which indicates one or more categories and the one or more users categorized into each category. In embodiments, commercial information analyzer 802 may be configured to classify users into any number of categories. For instance, FIG. 10 shows a block diagram of commercial information analyzer 802, according to an example embodiment. As shown in FIG. 10, commercial information analyzer 802 includes a shopping categorizer 1002, a frequent shopper categorizer 1004, a spending level categorizer 1006, a time-based purchaser categorizer 1008, an ad exclusion categorizer 1010, a purchase time categorizer 1012, a purchase frequency categorizer 1014, an average purchase amount categorizer 1016, a purchaser demographics categorizer 1018, a correlated purchase categorizer 1020, and a similar purchasing characteristics categorizer 1022. In embodiments, commercial information analyzer 802 may include any one or more of these categorizers shown in FIG. 10, as well as additional and/or alternative categorizers. The categorizers of FIG. 10 are described as follows.

Shopping categorizer 1002 is configured to analyze commercial information 510 to determine one or more users that purchased one or more items in a shopping category, and to indicate the users determined to be included in the shopping category in category information 806. For example, shopping categorizer 1002 may be configured to create shopper segments/categories based on types of purchases, as indicated by commercial information 510. For instance, commercial information 510 may indicate that a particular user received one or more email receipts from clothing retailers (e.g., the Gap, Ann Taylor, Banana Republic, etc.) for purchased clothing items, and therefore may categorize the user in a clothing shopper category. In the example described above, commercial information 510 may indicate that a particular user received one or more email receipts for purchased video games, and therefore may categorize the user in a video game shopper category. Commercial information 510 may indicate that a particular user received one or more email receipts from electronics retailers (e.g., Buy.com, Amazon, Fry's, etc.) for electronics items, and therefore may categorized the user in an electronics shopper category. Commercial information 510 may indicate that a particular user received one or more email receipts from a book retailer for book items, and therefore may categorize the user in a book reader category. Shopping categorizer 1002 may be configured to categorize users in any type and number of shopping categories. User classification data generator 804 is configured to generate user classification data 206 to indicate the users included in the shopping categories.

Frequent shopper categorizer 1004 is configured to analyze commercial information 510 to determine a number of commercial emails received by a user in a predetermined period of time. If a user receives at least a threshold number of commercial emails within the predetermined period of time, frequent shopper categorizer 1004 is configured to indicate the user to be included in a frequent shopper category. Frequent shopper categorizer 1004 may categorize users in a single frequent shopper category, or may categorize users across several frequent shopper categories. Examples of such frequent shopper categories include categories defined according to shopping frequency (e.g., based on the number of commercial emails received in the predetermined time period), according to product area (e.g. leisure travel, sports equipment, ticket buys), and/or according to further criteria. User classification data generator 804 is configured to generate user classification data 206 to indicate the users categorized in the one or more frequent shopper categories.

Spending level categorizer 1006 is configured to analyze commercial information 510 to determine an amount of money spent by a user in an item purchase indicated in a commercial email addressed to the user. If a user spends more money on an item purchase than a threshold amount, spending level categorizer 1006 may categorize the user in a high spender category. Spending level categorizer 1006 may categorize users in a single spending level category, or may categorize users across several spending level categories, which may be further categorized according to other factors, such as product area (e.g. leisure travel, sports equipment, ticket buys), number of items purchased (e.g., a single item or multiple items), etc. User classification data generator 804 is configured to generate user classification data 206 to indicate the users categorized in the one or more spending level categories.

Time-based purchaser categorizer 1008 is configured to analyze commercial information 510 to determine an expiration time indication indicated in a commercial email addressed to a user for an item, such as a leased or rented item. If an expiration time is indicated for the item, time-based purchaser categorizer 1008 may categorize the user in a time-based purchaser category based on the determined expiration time. For instance, a user may receive an email receipt for a car lease, and the email receipt may indicate the car lease is a three month lease. In such an example, the user may be categorized in a three-month car purchaser category because the user may likely be in the market for a new car or another car lease in three months (car manufacturers and/or dealers may be interested in receiving this the contents of this category to direct advertising to such users). User classification data generator 804 is configured to generate user classification data 206 to indicate the user in the time-based purchaser category.

Ad exclusion categorizer 1010 is configured to analyze commercial information 510 to determine an indication in a commercial email addressed to a user that the user owns an item of an item type, such as an indication that the user purchased the item (in an email receipt). If a determination is made that the user purchased the item, ad exclusion categorizer 1010 is configured to include the user in an exclusion category associated with the item type based on the determined indication (e.g., negative targeting of items). For instance, commercial information 510 may indicate that a user received an email receipt for a monthly mortgage payment. As a result, ad exclusion categorizer 1010 may determine that the user has a mortgage. Based on the user having a mortgage, ad exclusion categorizer 1010 may include the user in a mortgage ad exclusion category so that the user is not shown advertisements from mortgage lenders (e.g., Lending Tree, etc.). By excluding users from receiving advertisements for items that the users own/have purchased, user satisfaction may be increased through better ad relevance. User classification data generator 804 is configured to generate user classification data 206 to indicate that the user is included in the exclusion category.

In embodiments, commercial information analyzer 802 may be configured to analyze commercial information 510 to categorize users according to various factors that may be used to provide insight into a prospective audience for an advertisement campaign. For instance, purchase time categorizer 1012 is configured to analyze commercial information 510 to categorize users into a purchase time category according to a time of day, a day of week, a day of month, or other date/time indication, that users purchase their category of product. For example, purchase time categorizer 1012 may determine the date/time indication from the “Date:” field and/or other information extracted from commercial emails. Purchase frequency categorizer 1014 is configured to analyze commercial information 510 to categorize users into a purchase frequency category according to a frequency of item purchases. For example, purchase frequency categorizer 1014 may determine a purchase frequency for a user from a number of commercial emails that indicate periodic item purchases by the user. Average purchase amount categorizer 1016 is configured to analyze commercial information 510 to categorize users into an average purchase amount category according to an average amount spent by users on items in a particular product category. For example, average purchase amount categorizer 1016 may determine an average amount spent by a user by determining purchase amounts for items in a particular product category from email receipts of the user, and averaging the purchase amounts. Purchaser demographics categorizer 1018 is configured to analyze commercial information 510 to categorize users into one or more purchaser demographics categories. For instance, purchaser demographics categorizer 1018 may determine demographics of users that purchase products in a particular category, when present in commercial information 510, such as a sex of a user (male or female), age of a user, language of a user, geographic location of a user, etc., and may categorize the users in corresponding demographics categories. User classification data generator 804 is configured to generate user classification data 206 to indicate one or more users categorized in the purchase time category, the purchase frequency category, the average purchase amount category, and/or one or more purchaser demographics category.

Correlated purchase categorizer 1020 is configured to determine a plurality of purchases made by a user by analyzing commercial information 510. For example, correlated purchase categorizer 1020 may analyze a plurality of purchases made by the user, as indicated by commercial information extracted from a plurality of commercial emails addressed to the user. Correlated purchase categorizer 1020 may determine that the plurality of purchases are correlated (e.g., based on types of products that together create a holistic collection), and if so, include the user in a correlated purchases category. For instance, correlated purchases categorizer 1020 may determine that commercial information 510 indicates that a user purchased items from Diapers.com, Toy R'Us and Babies R'US (e.g., within a predetermined time period). In such case, correlated purchases categorizer 1020 may determine the user to be a parent and/or a mother (if gender of the user is female), and may include the user in a parents category and/or mom's category. User classification data generator 804 is configured to generate user classification data 206 to indicate the user in the correlated purchases category.

Similar purchasing characteristics categorizer 1022 is configured to analyze commercial information 510 to determine similar purchases made by a plurality of users (e.g., “lookalike targeting”). For instance, similar purchasing characteristics categorizer 1022 may determine that a plurality of users have performed at least one of having purchased a same item, purchased a same type of item, purchased an item from a same vendor, or spent a similar amount of money on a purchase. Based on the determination, similar purchasing characteristics categorizer 1022 may determine the plurality of users to have similar purchasing characteristics, and may include the users together in a similar purchasing characteristics category. For instance, in an embodiment, an advertiser may desire to determine a set of users that have particular characteristics. In an embodiment, the advertiser may provide a set of characteristics that the advertiser desires of the users. The advertiser may list the characteristics directly, or in other form, such as in the form of a set of conversions (e.g., a set of email receipts) associated with a set of users. Similar purchasing characteristics categorizer 1022 may be configured to determine users having characteristics matching the provided characteristics (e.g., matching the list of characteristics, matching the set of email receipts, etc.) to be grouped with the set of users. User classification data generator 804 is configured to generate user classification data 206 to indicate the matching users together in the similar purchasing characteristics category.

The next subsection describes example uses for user classification data.

### C. Examples Applications for User Classification Data

User classification data (e.g., user classification data 206) generated from commercial email according to embodiments of the present invention may be used in various applications. User classification can be used to target users, personally or anonymously, while they are browsing and/or logged into websites, including email sites or non-email sites. For example, user classification data generated from commercial email according to anonymous targeting techniques can be used to validate other conversion-based models (e.g., such as BT and search-based models such as search re-targeting), to train models that use conversion data such as behavioral targeting, to determine the likelihood of individuals with the same context (e.g., within a common email address book) making similar item purchases, to determine the likely sequencing and regularity of item purchases, and/or for other applications.

User classification data generated from commercial email according to personalized targeting techniques can be used in various ways, including being used to build user profiles representative of user purchase behavior. For instance, FIG. 11 shows a block diagram of a user profile generator 1102, according to an example embodiment. As shown in FIG. 11, user profile generator 1102 receives user classification data 206. User profile generator 1102 is configured to generate user profiles 1104 from user classification data 206. For example, in an embodiment, user profile generator 1102 may generate a user profile for each user that elected to opt-in to personalized targeting. User profile generator 1102 may generate a user profile for each user that indicates each category in which the user was categorized (e.g., by commercial information analyzer 802). For example, user profile generator 1102 may generate a user profile for Joseph Smith that indicates Joseph to be categorized in a video game shopper category, an infrequent shopper category, a low spender category, three-month car purchaser category a motorcycle ad exclusion category, a Monday purchaser category, a weekly purchaser category, a $50-$100 purchase amount category, a male category, a Midwestern geographic category, a parents category, etc.

Such user profiles may be used to improve online advertisement targeting, by using commercial email data as conversion data. Example for this type of personalized targeting include: targeting premium shoppers (by purchase volume or spend), creating granular individual user segments (e.g. book readers, mortgage owners, online shoe buyers), determining upsell users who have already purchased products at the time they are reading their email, determining correlations between multiple purchases and the types of users who make similar purchases, targeting users based on where they are within the subscription period for regular purchases (e.g. person with a car lease only has two month before the lease terminates), targeting users with complementary products to ones already purchased, and avoiding targeting users based on items already purchased to improve their advertising experience.

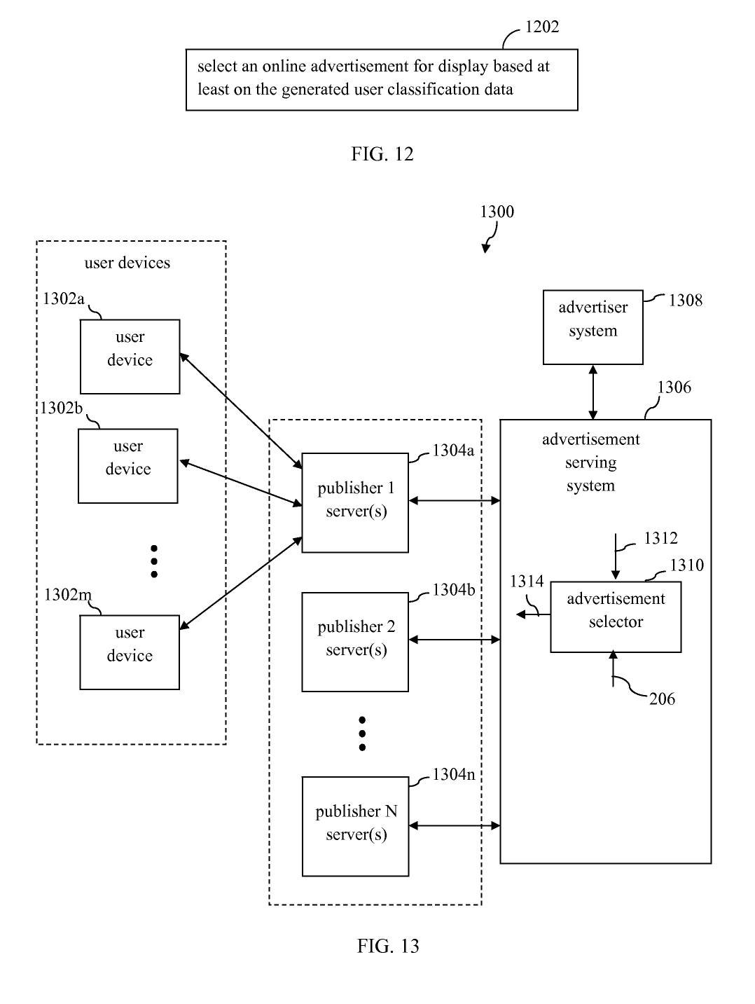

User classification data, including user profiles, may be used in online advertising embodiments in various ways. For instance, an advertisement selector may perform a step 1202 shown in FIG. 12, according to an embodiment. In step 1202, an online advertisement is selected for display based at least on the generated user classification data. FIG. 13 shows a block diagram of an example advertisement (“advertisement”) network 1300, according to an embodiment. As shown in FIG. 13, network 1300 includes an advertisement selector 1310. Advertisement selector 1310 may perform step 1202 of FIG. 12, in an embodiment. Advertisement network 1300 operates to serve advertisements provided by advertisers, such as display advertisements or other types of advertisements, to publisher sites (e.g., Web sites). When such sites are accessed by users of the network, the advertisements are displayed to the users. Advertisement network 1300 is an example display advertisement network provided for purposes of illustration. Advertisement selection using user classification data generated as described herein may also be used for advertisement selection in alternative environments. Advertisement network 1300 is described as follows.

As shown in FIG. 13, advertisement network 1300 includes a plurality of user devices 1302a-1302m, a plurality of publisher servers 1304a-1304n, an advertisement serving system 1306, and at least one advertiser system 1308. Communication among user devices 1302a-1302m, publisher servers 1304a-1304n, advertisement serving system 1306, and advertiser system 1308 is carried out over one or more networks using well-known network communication protocols. Example networks include a personal area network (PAN), a local area network (LAN), a wide-area network (WAN), a combination of networks such as the Internet, etc.

User devices 1302a-1302m are capable of communicating with any one or more of publisher servers 1304a-1304n in network 1300. For example, each of user devices 1302a-1302m may include a web browser that enables a user who owns (or otherwise has access to) the user system to access sites (e.g., websites) that are hosted by publisher servers 1304a-1304n. Each of user devices 1302a-1302m is shown in FIG. 13 to be communicatively coupled to publisher 1 server(s) 1304a to access a site published by publisher 1. Persons skilled in the relevant art(s) will recognize that each of user devices 1302a-1302m is capable of connecting to any of publisher servers 1304a-1304n for accessing the sites hosted thereon.

Publisher servers 1304a-1304n are capable of communicating with user devices 1302a-1302m in network 1300. Each of publisher servers 1304a-1304n is configured to host a site (e.g., a website) published by a corresponding publisher 1-N so that such site is accessible to users of network 1300 via user devices 1302a-1302m. Each of publisher servers 1304a-1304n is further configured to serve advertisement(s) to users of network 1300 when those users access a website that is hosted by the respective publisher server.

User devices 1302a-1302m may each be any type of electronic device configured with web browsing functionality (or other suitable network communication functionality), including a desktop computer (e.g., a personal computer, etc.), a mobile computing device (e.g., a personal digital assistant (PDA), a laptop computer, a notebook computer, a tablet computer (e.g., an Apple iPad™), a netbook, etc.), a mobile phone (e.g., a cell phone, a smart phone, etc.), or a mobile email device.

Advertisement serving system 1306 may receive advertisements from advertiser system 1308 and/or other sources. Advertisement serving system 1306 is configured to serve the advertisements to publisher servers 1304a-1304n when the sites hosted by servers 1304a-1304n are accessed by users, thereby facilitating the delivery of advertisements to the users. Advertisement serving system 1306 may be implemented in various ways, including in the form of one or more computing systems, such as one or more servers.

As shown in FIG. 13, advertisement serving system 1306 includes an advertisement selector 1310. Advertisement selector 1310 is configured to select the advertisements to be served to publisher servers 1304a-1304n, generating an advertisement selection 1314 that indicates the selected advertisement. As shown in FIG. 13, advertisement selector 1310 receives user classification data 206 and an advertisement request 1312. Advertisement request 1312 may be received from a publisher server 1304, for example. Advertisement request 1312 may indicate user information, including an identity of a user at a user device 1302 displaying a web page that requests an advertisement from a publisher server 1304, and/or further contextual information (e.g., an IP address for the user device, etc.). In response to advertisement request 1312, advertisement selector 1310 is configured to select an advertisement (e.g., from a pool of advertisements) based at least on user classification data 206. Although shown in FIG. 13 as receiving user classification data 206, advertisement selector 1310 may receive user profiles 1104 (FIG. 11), and may use user profiles 1104 to select an advertisement. In an embodiment, advertisement selector 1310 may be configured to match the advertisement request with user classification data 206 to select an advertisement. For instance, advertisement selector 1310 may determine a user profile of user profiles 1104 for the user identified in request 1312, and may select an advertisement based on the user profile, such as by matching categories that include the user with advertisement criteria.

For instance, Joseph Smith may have a user profile of user profiles 1104 that indicates Joseph to be categorized in a video game shopper category, a low spender category, a $50-$100 purchase amount category, and a Toledo, Ohio geographic category. Advertisement selector 1310 may match this user profile with an advertisement having attributes matching the categories of the user profile, such as an advertisement for a video game store located in Toledo, Ohio. Advertisement selection 1314 may indicate the selected advertisement. Advertisement serving system 1306 may serve the advertisement indicated by advertisement selection 1314 to the requesting publisher server 1304 or directly to the user device 1302 to be displayed to the user.

Advertisement selector 1310 may be configured to select advertisements in any manner, including by matching user classification data with advertisements as described above, by selecting upsell advertisements, by selecting advertisements for sequential sales, and/or by selecting advertisements in other ways.

For example, in an embodiment, advertisement selector 1310 may be configured to select an online advertisement for display to a user as an advertisement for an item selected as an upsell of another item indicated to have been previously purchased by the user. For instance, an email receipt may indicate a user to be a Netflix subscriber to the lowest tier plan. In an embodiment, advertisements for higher tier plans may be served to users that are categorized in a Netflix subscriber lower tier plan category. In an embodiment, if a subsequent email receipt indicates that a higher tier plan was purchased, the upsell opportunity may be closed out.

In another embodiment, advertisement selector 1310 may be configured to select the online advertisement for display to a user as an advertisement for a sequential sale item to an item indicated to have been previously purchased by the user. For instance, people who purchase trips to ski resorts often subsequently purchase ski equipment. User classification data 206 may include a segment or category of ski resort travelers (e.g., based on email receipts transmitted within last week). In an embodiment, advertisements for ski equipment may be served to users that are categorized in the ski trip travelers category. In another embodiment, information indicating the users included in the ski resort travelers category may be sold to ski equipment retailers for use by the ski equipment retailer. In an embodiment, if a subsequent email receipt indicates that the ski equipment was purchased, the sequential sale opportunity may be closed out.

### III. Example Computer Implementations

User classifier 202, user classifier 500, commercial email determiner 502, commercial email parser 504, commercial information processor 506, conversion indicator 512, email header analyzer 602, email body analyzer 604, privacy module 702, commercial information analyzer 802, user classification data generator 804, shopping categorizer 1002, frequent shopper categorizer 1004, spending level categorizer 1006, time-based purchaser categorizer 1008, ad exclusion categorizer 1010, purchase time categorizer 1012, purchase frequency categorizer 1014, average purchase amount categorizer 1016, purchaser demographics categorizer 1018, correlated purchase categorizer 1020, similar purchasing characteristics categorizer 1022, user profile generator 1102, and advertisement selector 1310 may be implemented in hardware, software, firmware, or any combination thereof. For example, user classifier 202, user classifier 500, commercial email determiner 502, commercial email parser 504, commercial information processor 506, conversion indicator 512, email header analyzer 602, email body analyzer 604, privacy module 702, commercial information analyzer 802, user classification data generator 804, shopping categorizer 1002, frequent shopper categorizer 1004, spending level categorizer 1006, time-based purchaser categorizer 1008, ad exclusion categorizer 1010, purchase time categorizer 1012, purchase frequency categorizer 1014, average purchase amount categorizer 1016, purchaser demographics categorizer 1018, correlated purchase categorizer 1020, similar purchasing characteristics categorizer 1022, user profile generator 1102, and/or advertisement selector 1310 may be implemented as computer program code configured to be executed in one or more processors. Alternatively, user classifier 202, user classifier 500, commercial email determiner 502, commercial email parser 504, commercial information processor 506, conversion indicator 512, email header analyzer 602, email body analyzer 604, privacy module 702, commercial information analyzer 802, user classification data generator 804, shopping categorizer 1002, frequent shopper categorizer 1004, spending level categorizer 1006, time-based purchaser categorizer 1008, ad exclusion categorizer 1010, purchase time categorizer 1012, purchase frequency categorizer 1014, average purchase amount categorizer 1016, purchaser demographics categorizer 1018, correlated purchase categorizer 1020, similar purchasing characteristics categorizer 1022, user profile generator 1102, and/or advertisement selector 1310 may be implemented as hardware logic/electrical circuitry.

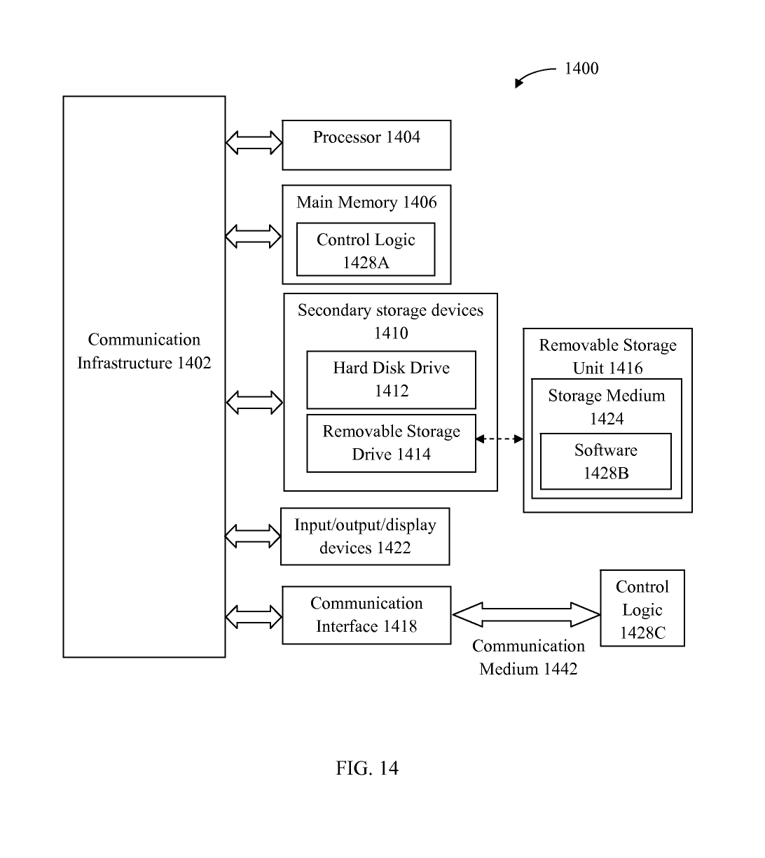

The embodiments described herein, including systems, methods/processes, and/or apparatuses, may be implemented using well known servers/computers, such as a computer 1400 shown in FIG. 14. For example, user device 102, email server 104, user device 106, email server 200, commercial entity device 302, user devices 1302a-1302m, publisher servers 1304a-1304n, advertisement serving system 1306, and/or advertiser system 1308 can be implemented using one or more computers 1400.

Computer 1400 can be any commercially available and well known computer capable of performing the functions described herein, such as computers available from International Business Machines, Apple, Sun, HP, Dell, Cray, etc. Computer 1400 may be any type of computer, including a desktop computer, a server, etc.

Computer 1400 includes one or more processors (also called central processing units, or CPUs), such as a processor 1404. Processor 1404 is connected to a communication infrastructure 1402, such as a communication bus. In some embodiments, processor 1404 can simultaneously operate multiple computing threads.

Computer 1400 also includes a primary or main memory 1406, such as random access memory (RAM). Main memory 1406 has stored therein control logic 1428A (computer software), and data.

Computer 1400 also includes one or more secondary storage devices 1410. Secondary storage devices 1410 include, for example, a hard disk drive 1412 and/or a removable storage device or drive 1414, as well as other types of storage devices, such as memory cards and memory sticks. For instance, computer 1400 may include an industry standard interface, such a universal serial bus (USB) interface for interfacing with devices such as a memory stick. Removable storage drive 1414 represents a floppy disk drive, a magnetic tape drive, a compact disk drive, an optical storage device, tape backup, etc.

Removable storage drive 1414 interacts with a removable storage unit 1416. Removable storage unit 1416 includes a computer useable or readable storage medium 1424 having stored therein computer software 1428B (control logic) and/or data. Removable storage unit 1416 represents a floppy disk, magnetic tape, compact disk, DVD, optical storage disk, or any other computer data storage device. Removable storage drive 1414 reads from and/or writes to removable storage unit 1416 in a well known manner.

Computer 1400 also includes input/output/display devices 1422, such as monitors, keyboards, pointing devices, etc.

Computer 1400 further includes a communication or network interface 1418. Communication interface 1418 enables the computer 1400 to communicate with remote devices. For example, communication interface 1418 allows computer 1400 to communicate over communication networks or mediums 1442 (representing a form of a computer useable or readable medium), such as LANs, WANs, the Internet, etc. Network interface 1418 may interface with remote sites or networks via wired or wireless connections.

Control logic 1428C may be transmitted to and from computer 1400 via the communication medium 1442.

Any apparatus or manufacture comprising a computer useable or readable medium having control logic (software) stored therein is referred to herein as a computer program product or program storage device. This includes, but is not limited to, computer 1400, main memory 1406, secondary storage devices 1410, and removable storage unit 1416. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for user classifier 202, user classifier 500, commercial email determiner 502, commercial email parser 504, commercial information processor 506, conversion indicator 512, email header analyzer 602, email body analyzer 604, privacy module 702, commercial information analyzer 802, user classification data generator 804, shopping categorizer 1002, frequent shopper categorizer 1004, spending level categorizer 1006, time-based purchaser categorizer 1008, ad exclusion categorizer 1010, purchase time categorizer 1012, purchase frequency categorizer 1014, average purchase amount categorizer 1016, purchaser demographics categorizer 1018, correlated purchase categorizer 1020, similar purchasing characteristics categorizer 1022, user profile generator 1102, advertisement selector 1310, flowchart 400, flowchart 900, and/or step 1202 (including any one or more steps of flowcharts 400 and 900), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
determining a plurality of commercial emails in an email store;
parsing the commercial emails to extract commercial information included in the commercial emails; and
processing the commercial information to generate user classification data.

2. The method of claim 1, wherein said determining comprises:
analyzing at least one of an email header or an email body of each of a plurality of emails in the email store for one or more commercial email indications; and
categorizing as a commercial email each email of the plurality of emails that includes one or more of the commercial email indications.

3. The method of claim 1, wherein said parsing comprises:
disassociating email recipient identity information from the extracted commercial information.

4. The method of claim 1, wherein said processing comprises:
analyzing the commercial information to determine one or more users that purchased one or more items in a shopping category; and
generating user classification data that categorizes the determined one or more users in the shopping category.

5. The method of claim 1, wherein said processing comprises:
analyzing the commercial information to determine a number of commercial emails received by a user in a period of time; and
generating user classification data that categorizes the user in a frequent shopper category based at least on the determined number of commercial emails.

6. The method of claim 1, wherein said processing comprises:
analyzing the commercial information to determine an amount of money spent by a user in an item purchase indicated in a commercial email addressed to the user; and
generating user classification data that categorizes the user in a spending level category based on the determined amount of money.

7. The method of claim 1, wherein said processing comprises:
analyzing the commercial information to determine an expiration time indication indicated in a commercial email addressed to a user for a leased item; and
generating user classification data that categorizes the user in a time-based purchaser category based on the determined expiration time.

8. The method of claim 1, wherein said processing comprises:
analyzing the commercial information to determine an indication in a commercial email addressed to a user that the user owns an item of an item type; and
generating user classification data that categorizes the user in an exclusion category associated with the item type based on the determined indication.

9. The method of claim 1, wherein said processing comprises:
generating user classification data that categorizes a user in at least one of a purchase time category, a purchase frequency category, an average purchase amount category, or a purchaser demographics category based at least on commercial information extracted from at least one commercial email addressed to the user.

10. The method of claim 1, wherein said processing comprises:
determining a plurality of purchases made by a user from commercial information extracted from a plurality of commercial emails addressed to the user;
determining that the plurality of purchases are correlated; and
generating user classification data that categorizes the user in a category based on the correlated purchases.

11. The method of claim 1, wherein said processing comprises:
analyzing the commercial information to determine that a plurality of users have performed at least one of having purchased a same item, purchased a same type of item, purchased an item from a same vendor, or spent a similar amount of money on a purchase;
determining the plurality of users to have similar purchasing characteristics based on said analyzing; and
generating user classification data that categorizes the plurality of users together in a similar purchasing characteristics category.

12. The method of claim 1, further comprising:
generating a user profile for a user based at least on one or more categories in the user classification data that include the user.

13. The method of claim 1, further comprising:
selecting an online advertisement for display based at least on the generated user classification data.

14. The method of claim 13, wherein said selecting comprises:
selecting the online advertisement for display to a user as an advertisement for an item selected based on a category associated with the user in the user classification data.

15. The method of claim 13, wherein said selecting comprises:
selecting the online advertisement for display to a user as an advertisement for an item selected as an upsell of another item indicated to have been previously purchased by the user.

16. The method of claim 13, wherein said selecting comprises:
selecting the online advertisement for display to a user as an advertisement for a sequential sale item to an item indicated to have been previously purchased by the user.

17. The method of claim 1, further comprising:
using the determined commercial emails to indicate conversions.

18. A user classifier, comprising:
a commercial email determiner configured to determine a plurality of commercial emails in an email store;
a commercial email parser configured to parse the commercial emails to extract commercial information included in the commercial emails; and
a commercial information processor configured to process the commercial information to generate user classification data.

19. The user classifier of claim 18, wherein the commercial information processor comprises:
a commercial information analyzer configured to analyze the commercial information to categorize one or more users in one or more categories; and
a user classification data generator configured to generate user classification data that indicates the one or more users categorized in the one or more categories.

20. The user classifier of claim 19, wherein the commercial information analyzer is configured to analyze the commercial information to categorize one or more users in at least one of a shopping category, a frequent shopper category, a spending level category, a time-based purchaser category, a purchase time category, a purchase frequency category, an average purchase amount category, a purchaser demographics category, or a similar purchasing characteristics category.

21. The user classifier of claim 19, wherein the commercial information analyzer is configured to analyze the commercial information to determine an indication in a commercial email addressed to a user that the user owns an item of an item type; and
wherein the user classification data generator is configured to generate user classification data that includes the user in an exclusion category associated with the item type based on the determined indication.

22. The user classifier of claim 19, wherein the commercial information analyzer is configured to determine a plurality of purchases made by a user from commercial information extracted from a plurality of commercial emails addressed to the user, and to determine that the plurality of purchases are correlated; and
wherein the user classification data generator is configured to generate user classification data that categorizes the user in a category based on the correlated purchases.

23. The user classifier of claim 19, wherein the commercial information analyzer is configured to analyze the commercial information to determine that a plurality of users have performed at least one of having purchased a same item, purchased a same type of item, purchased an item from a same vendor, or spent a similar amount of money on a purchase, and to determine the plurality of users to have similar purchasing characteristics; and
wherein the user classification data generator is configured to generate user classification data that categorizes the plurality of users together in a similar purchasing characteristics category.

24. The user classifier of claim 18, further comprising:
a user profile generator configured to generate a user profile for a user based at least on one or more categories in the user classification data that include the user.

25. The user classifier of claim 18, further comprising:
an advertisement selector configured to select an online advertisement for display based at least on the generated user classification data.

26. A computer program product comprising a computer-readable medium having computer program logic recorded thereon for enabling a processor to classify users, comprising:
first computer program logic means for enabling the processor to determine a plurality of commercial emails in an email store;
second computer program logic means for enabling the processor to parse the commercial emails to extract commercial information included in the commercial emails; and
third computer program logic means for enabling the processor to process the commercial information to generate user classification data.
